(19) United States
(12) Patent Application Publication
(10) Pub. No.: US 2021/0385485 A1
(43) Pub. Date: Dec. 9, 2021

(54) ANGULAR WEIGHTED PREDICTION FOR INTER PREDICTION

(71) Applicant: ALIBABA GROUP HOLDING LIMITED, George Town (KY)

(72) Inventors: Ruling LIAO, Beijing (CN); Jie CHEN, Beijing (CN); Yan YE, San Diego, CA (US)

(21) Appl. No.: 17/340,611

(22) Filed: Jun. 7, 2021

Related U.S. Application Data
(60) Provisional application No. 63/035,695, filed on Jun. 6, 2020.

(51) Int. Cl. H04N 19/52; H04N 19/184; H04N 19/109

(52) U.S. Cl. CPC H04N 19/52; H04N 19/109; H04N 19/184

(57) ABSTRACT

The present disclosure provides a computer-implemented method for decoding video. The method includes: receiving a bitstream comprising a first flag indicating whether an angular weighted prediction (AWP) mode is used for a coded unit; and in response to a determination that the AWP mode is used for the coded unit, decoding the bitstream in the AWP mode for an inter prediction.

### CROSS-REFERENCE TO RELATED APPLICATIONS

This disclosure claims the benefit of priority to U.S. Provisional Application No. 63/035,695, filed on Jun. 6, 2020, which is incorporated herein by reference in its entirety.

### TECHNICAL FIELD

The present disclosure generally relates to video processing, and more particularly, to methods and apparatus for video frame prediction using angular weighted prediction mode in inter prediction.

### BACKGROUND

A video is a set of static pictures (or “frames”) capturing visual information. To reduce memory storage space and the transmission bandwidth, a video can be compressed before storage or transmission and decompressed before display. The compression process is usually referred to as encoding and the decompression process is usually referred to as decoding. There are various video coding formats which use standardized video coding technologies, for example, based on prediction, transform, quantization, entropy coding and/or in-loop filtering. Video coding standards, such as the High Efficiency Video Coding (HEVC/H.265) standard, the Versatile Video Coding (VVC/H.266) standard, and Audio Video coding Standard (AVS) standards, specifying the specific video coding formats, are developed by standardization organizations. With more and more advanced video coding technologies being adopted in the video standards, the coding efficiency of new video coding standards has improved.

### SUMMARY OF THE DISCLOSURE

Embodiments of the present disclosure provide a video encoding method including receiving one or more video frames; and coding the one or more video frames using an angular weighted prediction (AWP) mode for inter prediction by signaling two items of motion information including a motion vector difference (MVD) and a reference index.

Embodiments of the present disclosure provide a video decoding method including receiving a bitstream comprising a first flag indicating whether an angular weighted prediction (AWP) mode is used for a coded unit; and in response to a determination that the AWP mode is used for the coded unit, decoding the bitstream in the AWP mode for inter prediction.

Embodiments of the present disclosure provide an apparatus for performing video data processing. The apparatus includes a memory configured to store instructions; and one or more processors communicatively coupled to the memory and configured to execute the instructions to cause the apparatus to perform receiving one or more video frames; and coding the one or more video frames using an angular weighted prediction (AWP) mode for inter prediction by signaling two items of motion information including a motion vector difference (MVD) and a reference index.

Embodiments of the present disclosure provide an apparatus for performing video data processing. The apparatus includes a memory configured to store instructions; and one or more processors communicatively coupled to the memory and configured to execute the instructions to cause the apparatus to perform receiving a bitstream comprising a first flag indicating whether an angular weighted prediction (AWP) mode is used for a coded unit; and in response to a determination that the AWP mode is used for the coded unit, decoding two items of motion information including a motion vector difference (MVD) and a reference index; and decoding the bitstream in the AWP mode for inter prediction.

Embodiments of the present disclosure provide a non-transitory computer-readable storage medium that stores a set of instructions that is executable by one or more processors of an apparatus to cause the apparatus to initiate a method for performing video data processing. The method includes receiving one or more video frames; and coding the one or more video frames using an angular weighted prediction (AWP) mode for inter prediction by signaling two items of motion information including a motion vector difference (MVD) and a reference index.

Embodiments of the present disclosure provide a non-transitory computer-readable storage medium that stores a set of instructions that is executable by one or more processors of an apparatus to cause the apparatus to initiate a method for performing video data processing. The method includes receiving a bitstream comprising a first flag indicating whether an angular weighted prediction (AWP) mode is used for a coded unit, and in response to a determination that the AWP mode is used for the coded unit, decoding two items of motion information including a motion vector difference (MVD) and a reference index; and decoding the bitstream in the AWP mode for inter prediction.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an exemplary video sequence, according to some embodiments of the present disclosure.

FIG. 2A is a schematic diagram illustrating an exemplary encoding process of a hybrid video coding system, consistent with embodiments of the disclosure.

FIG. 2B is a schematic diagram illustrating another exemplary encoding process of a hybrid video coding system, consistent with embodiments of the disclosure.

FIG. 3A is a schematic diagram illustrating an exemplary decoding process of a hybrid video coding system, consistent with embodiments of the disclosure.

FIG. 3B is a schematic diagram illustrating another exemplary decoding process of a hybrid video coding system, consistent with embodiments of the disclosure.

FIG. 4 is a block diagram of an exemplary apparatus for encoding or decoding a video, according to some embodiments of the present disclosure.

FIG. 5 shows an exemplary spatial motion vector predictor derived from six neighboring blocks, according to some embodiments of the present disclosure.

FIG. 6 shows examples of intra prediction angles supported in angular weighted prediction (AWP) mode, according to some embodiments of the present disclosure.

FIG. 7 shows exemplary weight array settings in AWP mode, according to some embodiments of the present disclosure.

FIG. 8 shows an exemplary angular weighted prediction (AWP) process, according to some embodiments of the present disclosure.

FIG. 9 shows an exemplary correlation between a motion vector resolution (MVR) index and a motion vector difference (MVD) precision, according to some embodiments of the present disclosure.

FIG. 10 shows an exemplary correlation between an adaptive motion vector resolution (AMVR) index and history-based motion vector predictor (HMVP) index, according to some embodiments of the present disclosure.

FIG. 11 shows a flow-chart of an exemplary method for encoding video frame using AWP mode, according to some embodiments of the present disclosure.

FIG. 12 shows a flow-chart for extending an AWP mode to an inter prediction at coding-unit level, according to some embodiments of the present disclosure.

FIG. 13A and FIG. 13B show an exemplary syntax structure associated with the flow-chart in FIG. 12, according to some embodiments of the present disclosure.

FIG. 14 shows an exemplary flow-chart for signaling an AWP flag prior to an SMVD flag, according to some embodiments of the present disclosure.

FIG. 15 shows an exemplary flow-chart for signaling an AWP flag prior to a bi-prediction flag, according to some embodiments of the present disclosure.

FIG. 16 shows an exemplary flow-chart for signaling an AWP flag based on an EMVR flag, according to some embodiments of the present disclosure.

FIG. 17 shows another exemplary flow-chart for signaling an AWP flag based on an extended motion vector resolution (EMVR) flag, according to some embodiments of the present disclosure.

FIG. 18 shows a flow-chart of an exemplary method for decoding video frame using AWP mode, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

New standards for video coding are being developed in the industry. For example, the Audio Video coding Standard (“AVS”) Workgroup is developing a third generation of AVS video standard, namely AVS3. High Performance Model (“HPM”) has been chosen by the workgroup as a new reference software platform for AVS3. The first phase of the AVS3 standard was able to achieve more than 20% coding performance gain over its predecessor AVS2, and the second phase of the AVS3 standard is still under development.

A video is a set of static pictures (or “frames”) arranged in a temporal sequence to store visual information. A video capture device (e.g., a camera) can be used to capture and store those pictures in a temporal sequence, and a video playback device (e.g., a television, a computer, a smartphone, a tablet computer, a video player, or any end-user terminal with a function of display) can be used to display such pictures in the temporal sequence. Also, in some applications, a video capturing device can transmit the captured video to the video playback device (e.g., a computer with a monitor) in real-time, such as for surveillance, conferencing, or live broadcasting.

For reducing the storage space and the transmission bandwidth needed by such applications, the video can be compressed before storage and transmission and decompressed before display. The compression and decompression can be implemented by software executed by a processor (e.g., a processor of a generic computer) or specialized hardware. A module for compression is generally referred to as an “encoder,” and a module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) includes changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

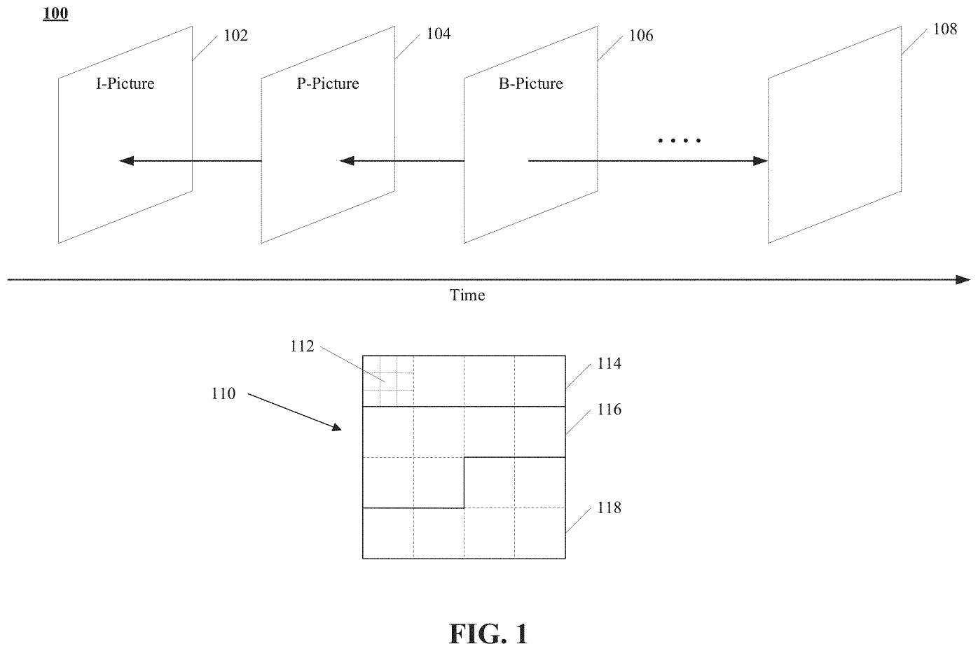

The AVS standard (e.g., AVS3) is based on the same hybrid video coding system that has been used in modern video compression standards, such as H.264/AVC, H.265/HEVC, etc. FIG. 1 illustrates structures of an exemplary video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 includes a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) do not necessarily immediately precede or follow the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC or H.266/VVC). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC or H.266NVC). Any operation performed on a basic processing unit can be repeatedly performed on each of its luma and chroma components.

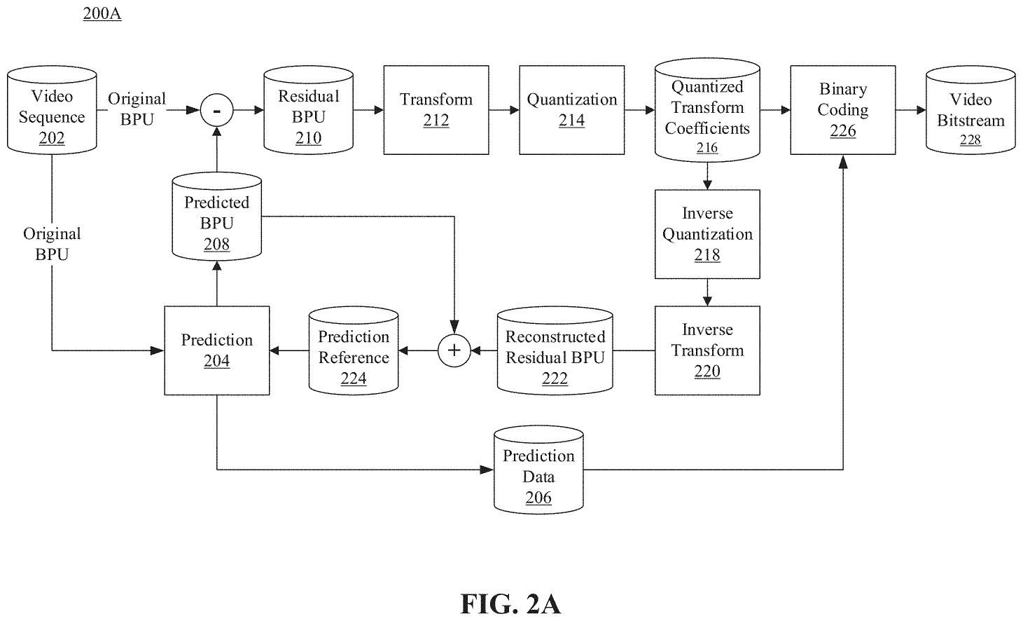

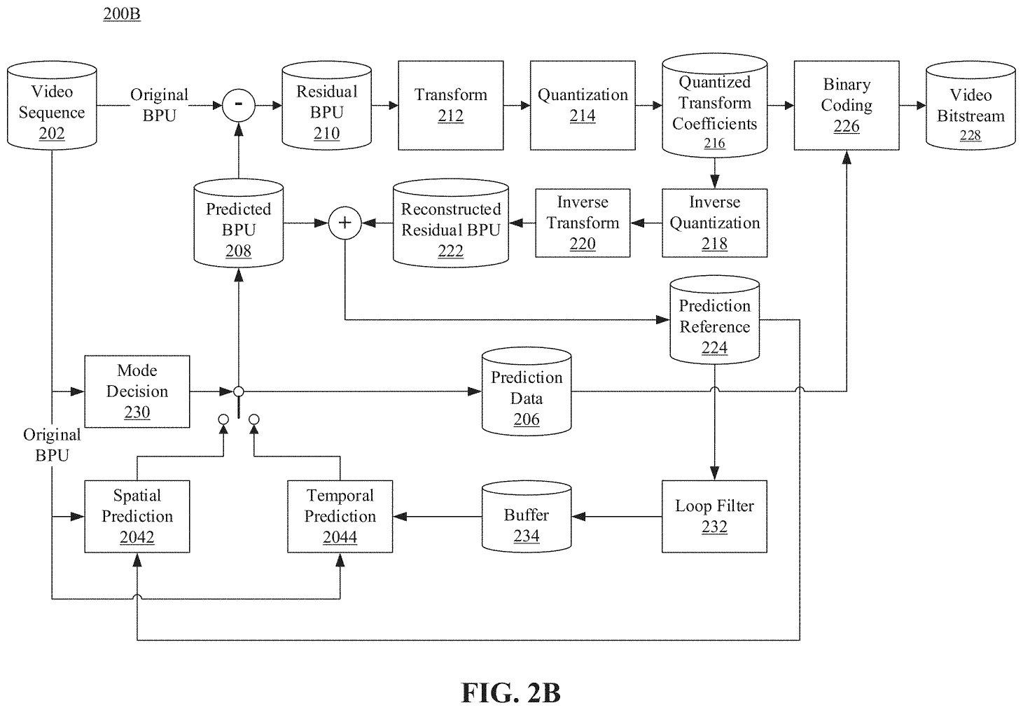

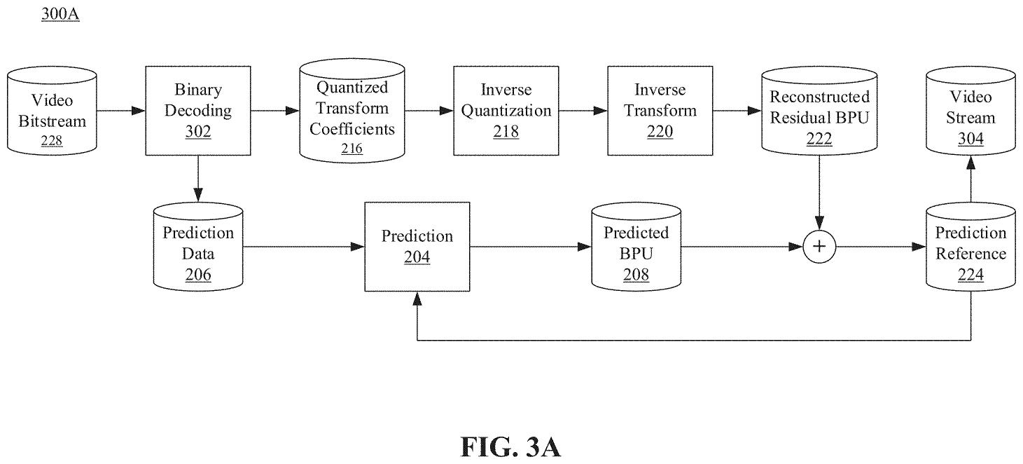

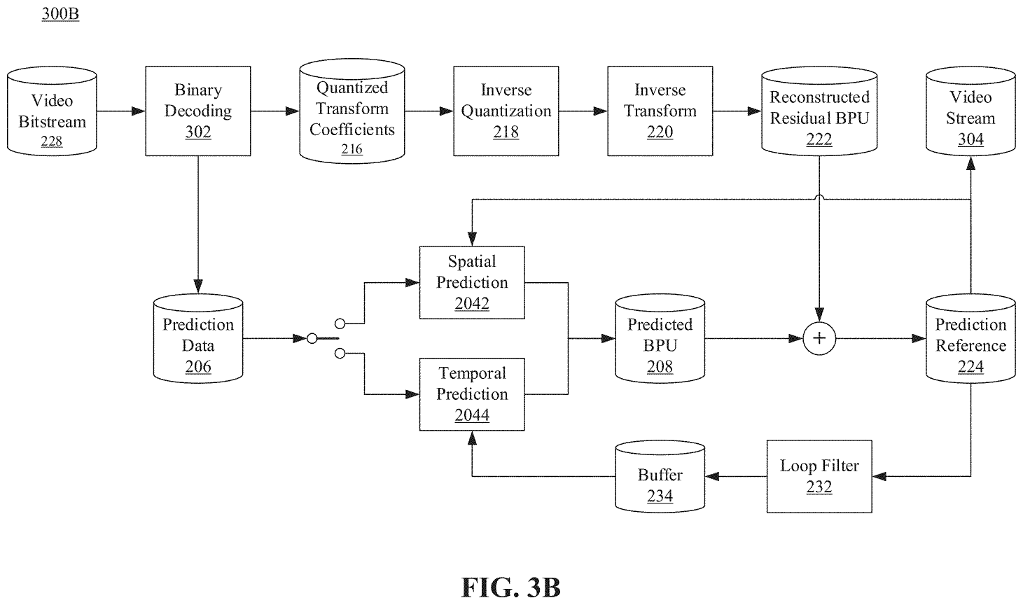

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, or H.264/AVC), or as “coding units” (“CUs”) in some other video coding standards (e.g., H.265/HEVC or H.266NVC). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed on a basic processing sub-unit can be repeatedly performed on each of its luma and chroma components. It should be noted that such division of processing units and sub-units can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC or H.266/VVC), and decide a prediction type for each individual basic processing sub-unit.

As another example, at a prediction stage (an example of which is shown in FIGS. 2A-2B), the encoder can perform a prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC or H.266/VVC), at the level of which the prediction operation can be performed.

As another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC or H.266/VVC), at the level of which the transform operation can be performed. It should be noted that the division schemes of the same basic processing sub-unit can be different at the prediction stage and the transform stage. For example, in H.265/HEVC or H.266NVC, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC and H.266NVC provide two types of regions: “slices” and “tiles.” It is also noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It is noted that the basic processing units, basic processing sub-units, and regions of structure 110 in FIG. 1 are only examples, and the present disclosure does not limit embodiments thereof.

FIG. 2A illustrates a schematic diagram of an exemplary encoding process 200A, consistent with embodiments of the disclosure. For example, the encoding process 200A can be performed by an encoder. As shown in FIG. 2A, the encoder can encode a video sequence 202 into a video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to a prediction stage 204 to generate prediction data 206 and a predicted BPU 208. The encoder can subtract predicted BPU 208 from the original BPU to generate a residual BPU 210. The encoder can feed residual BPU 210 to a transform stage 212 and a quantization stage 214 to generate quantized transform coefficients 216. The encoder can feed prediction data 206 and quantized transform coefficients 216 to a binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to an inverse quantization stage 218 and an inverse transform stage 220 to generate a reconstructed residual BPU 222. The encoder can add reconstructed residual BPU 222 to predicted BPU 208 to generate a prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224, and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometric functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can multiply values of corresponding pixels of the base patterns by respective associated coefficients and add the products to produce a weighted sum. For a video coding standard, both the encoder and decoder can use the same transform algorithm (thus the same base patterns). Thus, the encoder only needs to record the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It is noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another exemplary encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes a mode decision stage 230 and divides prediction stage 204 into a spatial prediction stage 2042 and a temporal prediction stage 2044. The reconstruction path of process 200B additionally includes a loop filter stage 232 and a buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

As another example, at temporal prediction stage 2044, the encoder can perform inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if the intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an exemplary decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into a video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder feeds a portion of video bitstream 228 associated with a basic processing unit (referred to as an “encoded BPU”) of an encoded picture to a binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate prediction reference 224. In some embodiments, prediction reference 224 can be stored in a buffer (e.g., a decoded picture buffer in a computer memory).

The decoder can feed prediction reference 224 to prediction stage 204 for performing a prediction operation in the next iteration of process 300A.

The decoder can perform process 300A iteratively to decode each encoded BPU of the encoded picture and generate prediction reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another exemplary decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described above with reference to FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described above with reference to FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in as the manner described above with reference to FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

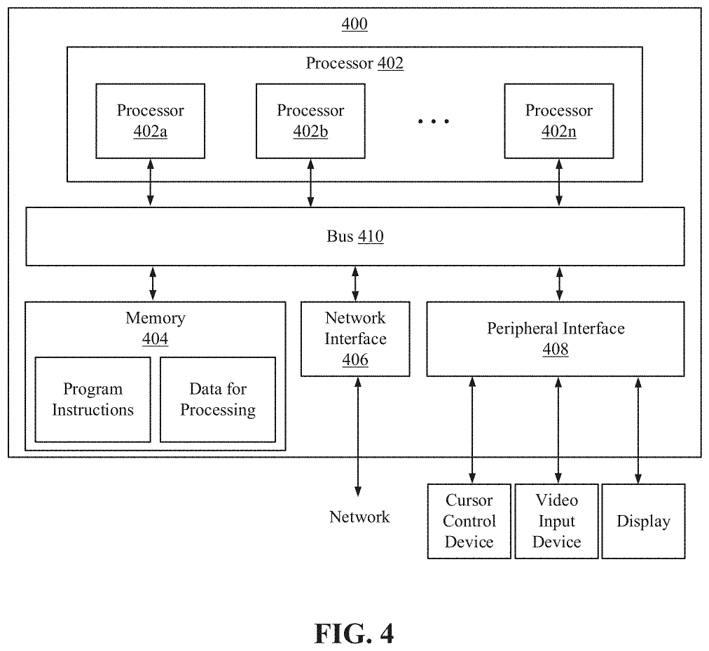

FIG. 4 is a block diagram of an example apparatus 400 for encoding or decoding a video, consistent with embodiments of the disclosure. As shown in FIG. 4, apparatus 400 includes a processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 also includes a memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

A bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include a network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, an near-field communication (“NFC”) adapter, a cellular network chip, or the like.

In some embodiments, optionally, apparatus 400 can further include a peripheral interface 408 to provide a connection to one or more peripheral devices. As shown in FIG. 4, the peripheral device can include, but is not limited to, a cursor control device 410 (e.g., a mouse, a touchpad, or a touchscreen), a keyboard, a display 412 (e.g., a cathode-ray tube display, a liquid crystal display, or a light-emitting diode display), a video input device 414 (e.g., a camera or an input interface coupled to a video archive), or the like.

It is noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. As another example, some or all stages of process 200A, 200B, 300A, or 300B can be implemented as one or more hardware modules of apparatus 400, such as a specialized data processing circuit (e.g., an FPGA, an ASIC, an NPU, or the like).

Skip mode and direct mode are two special inter modes in AVS3 in which the motion information including a reference index and a motion vector are not signaled in the bitstream but derived at the decoder side with same rules as in the encoder. These two modes share the same motion information derivation rule, and a difference between them is that the skip mode skips the signaling of residual BPUs by setting the residual BPUs (e.g., 222 in FIG. 3A and FIG. 3B) to be zero. As there are no residua signaled in skip mode, the quantized transform coefficients (e.g., 216 in FIG. 3A and FIG. 3B) are all zero and are not signaled. Therefore, the inverse quantization (e.g., 218 in FIG. 3A and FIG. 3B) and inverse transform (e.g., 220 in FIG. 3A and FIG. 3B) are skipped. Compared with normal inter modes, the bits dedicated on the motion information can be saved in the skip and direct modes, although the encoder follows the rule specified in the standard to derive the motion vector and the reference index to perform inter prediction. Therefore, the skip mode and the direct mode are suitable for cases in which the motion information of a current block is close to that of a spatial or temporal neighboring block, since the derivation of the motion information is based on the spatial or temporal neighboring block.

To derive the motion information used in inter prediction in the skip and direct modes, the encoder derives a list of motion candidates first, and then selects one or more of them to perform the inter prediction. The index of the selected candidate is signaled in the bitstream. On the decoder side, the decoder derives the same list of motion candidates as the encoder, and then uses the index parsed from the bitstream to obtain the motion used for inter prediction and then perform inter prediction.

In AVS (e.g., AVS3), there are 12 motion candidates in the candidate list. The first candidate is a temporal motion vector predictor (TMVP) which is derived from the motion vector (MV) of a collocated block in a certain reference frame. The certain reference frame here is specified as a reference frame with reference index being 0 in a reference picture list 1 for B frame or a reference picture list 0 for P frame. When the MV of the collocated block is unavailable, an MV predictor (MVP) derived according to the MV of spatial neighboring blocks is used as the TMVP.

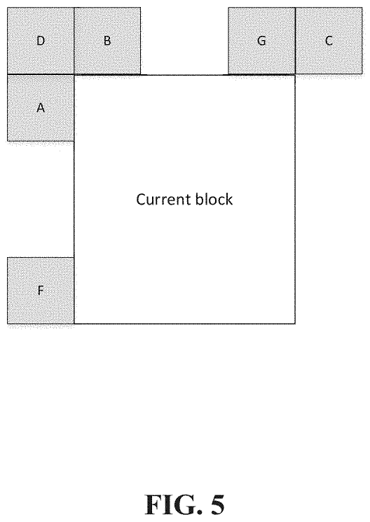

The second, third and fourth candidates are the spatial motion vector predictor (“SMVP”) which are derived from the six neighboring blocks. FIG. 5 shows an example of a spatial motion vector predictor derived from six neighboring blocks, according to some embodiments of the present disclosure. As shown in FIG. 5, the six neighboring blocks are named F, G, C, A, B, and D. The second candidate is a bi-prediction candidate, the third candidate is a uni-prediction candidate with a reference frame in reference picture list 0, and the fourth candidate is a uni-prediction candidate with a reference frame in reference picture list 1. These three candidates are set to the first available MV of the six neighboring blocks in a specified order. After deriving SMVP candidates, the motion vector angular prediction candidates (MVAP) and history-based motion vector predictor candidates (HMVP) are added.

In AVS (e.g., AVS3), an angular weighted prediction (AWP) mode is supported for the skip and direct modes. The AWP mode is signaled using a CU-level flag as one kind of skip or direct mode. First, in the AWP mode, a motion vector candidate list, which includes five different uni-prediction motion vectors, is constructed by deriving motion vectors from spatial neighboring blocks and the temporal motion vector predictor. Second, two uni-prediction motion vectors are selected from the motion vector candidate list to predict the current block. Unlike the bi-prediction inter mode which has equal weights for all samples, each sample coded in AWP mode may have a different weight.

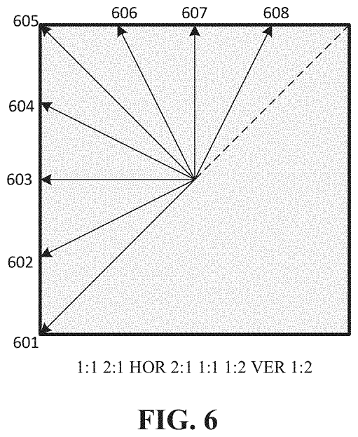

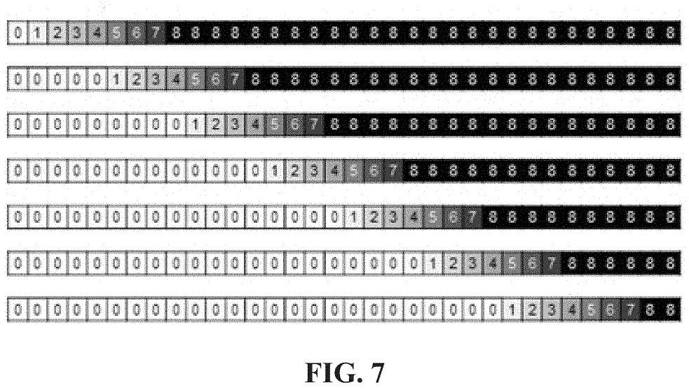

FIG. 6 shows exemplary intra prediction angles supported in AWP mode, according to some embodiments of the present disclosure. As shown in FIG. 6, there can be 8 different intra prediction angles respectively corresponding to 1:1 (e.g., 601), 2:1 (e.g., 602), horizontal (e.g., 603), 2:1 (e.g., 604), 1:1 (e.g., 605), 1:2 (e.g., 606), vertical (e.g., 607), and 1:2 (e.g., 608). FIG. 7 shows exemplary weight array settings in the AWP mode, according to some embodiments of the present disclosure. As shown in FIG. 7, there can be seven different weight array settings corresponding to the illustrated seven rows of weights. For example, the weight values for each weight array are range from 0 to 8. Referring to FIG. 6 and FIG. 7, a total of 56 different weights are supported in AWP mode for each possible coding unit (CU) size w×h=2^{m}×2ⁿ with m, n∈{3 . . . 6} including eight intra prediction angles and seven different weight array settings.

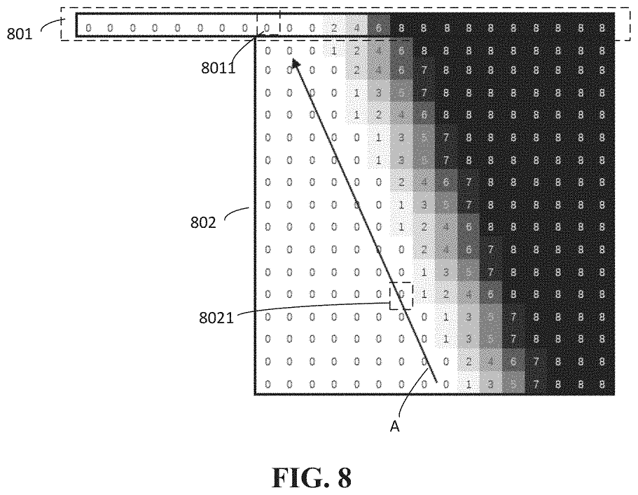

FIG. 8 shows an exemplary weight array for use in AWP weight prediction, according to some embodiments of the present disclosure. As shown in FIG. 8, the weights for each sample are predicted from the weight array 801, which has weight values (e.g., ranging from 0 to 8), according to different intra prediction angles. For example, the weight for a sample 8021 is predicted from the value of the element 8011 in the weight array 801 (e.g., 0), following an intra prediction angle (e.g., shown as arrow A). The intra prediction angle shown by arrow A could be the intra prediction angle 606 with a ratio of 1:2, as illustrated in FIG. 6. Finally, a weight matrix 802 is derived from the prediction method. The AWP weight prediction is similar to the process of intra prediction mode.

Assuming that the two selected uni-prediction motion vectors are Mv0 and Mv1. Two prediction blocks, P0 and P1, are obtained by performing motion compensation using Mv0 and Mv1, respectively. The final prediction block P is calculated as follows:

P=(P0×w0+P1×(8−w0))>>3

where the variable w0 is the weight matrix (e.g., 802 in FIG. 8) derived by the aforementioned AWP weight prediction. The weight matrix for P0 and the weight matrix for P1 are complementary in term of the maximum value of the weight.

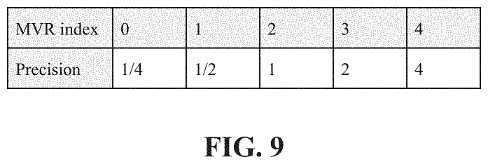

In AVS (e.g., AVS3), a CU-level adaptive motion vector resolution scheme is introduced. Adaptive motion vector resolution (AMVR) allows a motion vector difference (MVD) of the CU to be coded in different precisions including quarter-luma-sample, half-luma-sample, integer-luma-sample, two-luma-sample, or four-luma-sample. When a block is coded in regular inter prediction mode (e.g., the motion vector of the block is formed by adding a motion vector predictor and a motion vector difference), a motion vector resolution (MVR) index is signaled to indicate which precision is used to code the MVD. FIG. 9 shows an exemplary correlation between MVR index and MVD precision, according to some embodiments of the present disclosure. In addition, when the MVR index is not equal to 0, the motion vector predictor is rounded to the same precision as that of MVD, and then added to MVD to form the final MV.

The history-based motion vector predictor (HMVP) is derived from motion information of the previously encoded or decoded blocks. After encoding or decoding an inter coded block, the motion information is added to the last entry of an HMVP table where, for example, the size of the HMVP table is set to eight. When inserting a new motion candidate in the table, a constraining first-in-first-out (FIFO) rule is utilized by which redundancy check is applied to find whether there is an identical motion candidate already in the table. If there is an identical motion candidate in the table, the identical motion candidate is moved to the last entry of the table instead of inserting the new identical entry. The candidates in the HMVP table can be used as HMVP candidates for the skip and direct modes. The HMVP table is checked from the last entry to the first entry. If a candidate in the HMVP table is not identical to any temporal motion vector predictor (TMVP) candidate and spatial motion vector predictor (SMVP) candidate in the candidate list of the skip and direct modes, the candidate in the HMVP table is placed into the candidate list of the skip and direct modes as an HMVP candidate. If a candidate in the HMVP table is the same as one of the TMVP candidate or SMVP candidate, this candidate is not placed into the candidate list of the skip and direct modes. This process is referred to as “pruning.”

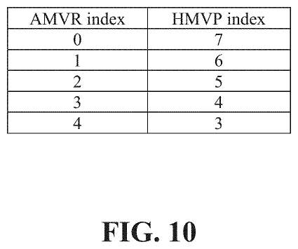

Extended motion vector resolution (EMVR) is a combination of HMVP and AMVR. In an EMVR mode, five motion vector predictors are obtained from the HMVP list, and each motion vector predictor is tied with a fixed motion vector difference precision. FIG. 10 shows an exemplary correlation between AMVR Index and HMVP Index, according to some embodiments of the present disclosure. For a block coded in regular inter prediction mode, a flag is signaled to indicate whether the EMVR mode is used or not. When the EMVR mode is used, an index is further signaled to indicate which motion vector in the HMVP correlation (FIG. 10) and MVD precision are used.

In AVS (e.g., AVS3), the AWP mode is only supported in the skip and direct modes. The benefits of the AWP mode have not been applied to the regular inter prediction mode. As a result, if the AWP mode can be extended to the regular inter prediction mode, the coding efficiency of AVS can be improved.

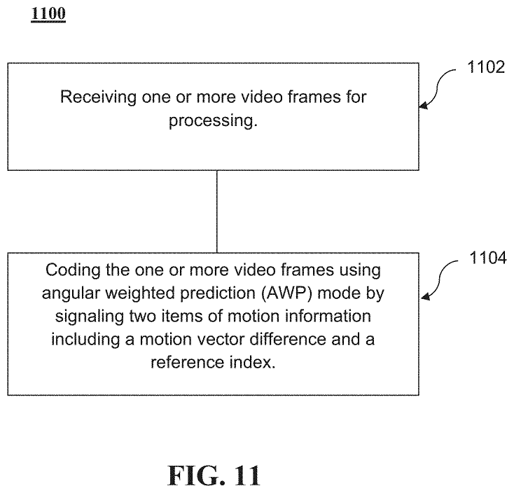

Embodiments of the present disclosure provide methods to incorporate the AWP mode into the regular inter prediction mode. FIG. 11 shows a flow-chart of an encoding method 1100 according to some embodiments of present disclosure. Method 1100 can be performed by an encoder (e.g., by process 200A of FIG. 2A or 200B of FIG. 2B) or performed by one or more software or hardware components of an apparatus (e.g., apparatus 400 of FIG. 4). For example, a processor (e.g., processor 402 of FIG. 4) can perform method 1100. In some embodiments, method 1100 can be implemented by a computer program product, embodied in a computer-readable medium, including computer-executable instructions, such as program code, executed by computers (e.g., apparatus 400 of FIG. 4). Referring to FIG. 11, method 1100 may include the following steps 1102 and 1104. At step 1102, one or more video frames are received for processing. At step 1104, the one or more video frames are coded using the angular weighted prediction (AWP) mode by signaling two items of motion information including a motion vector difference and a reference index. The AWP mode can be used in the regular inter prediction mode, for example the inter prediction mode is not a skip mode or a direct mode. The motion information includes a motion vector difference and a reference index. In some embodiments, to apply the AWP mode, a CU-level flag can be signaled to indicate whether the AWP mode is used in the regular inter prediction mode.

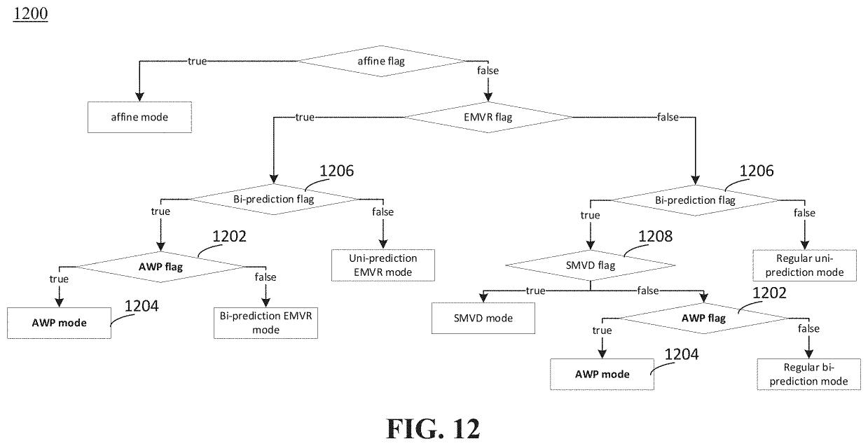

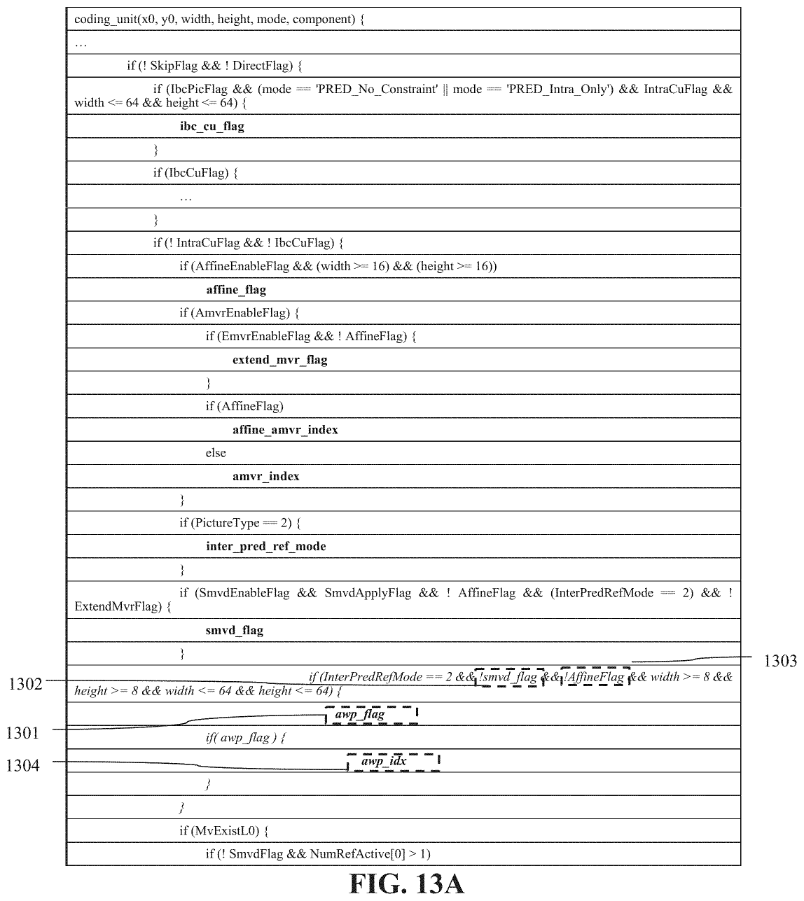

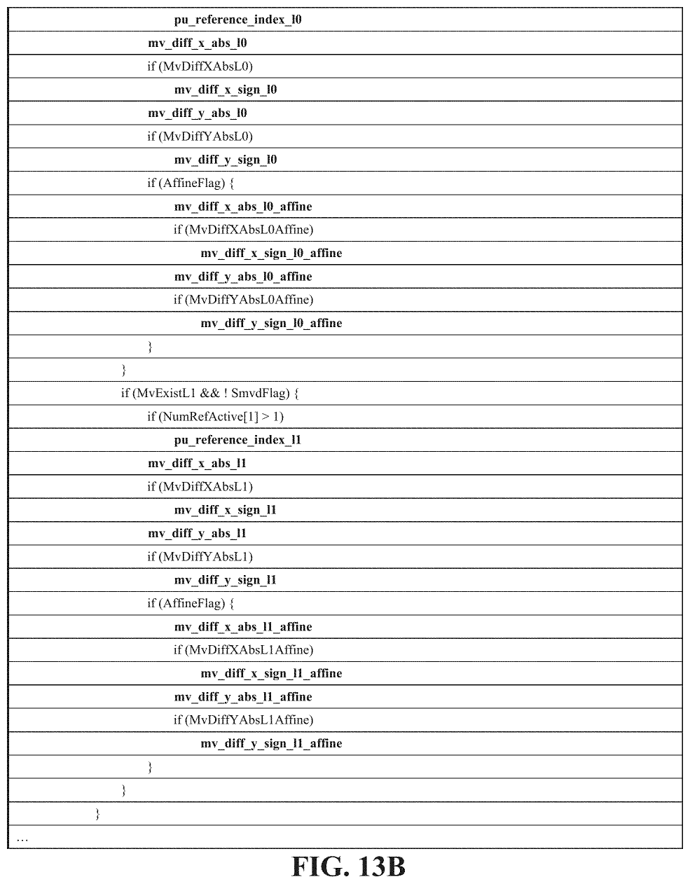

FIG. 12 shows an exemplary method 1200 for signaling an AWP flag at coding-unit level, according to some embodiments of the present disclosure. As shown in FIG. 12, an AWP flag 1202 and an AWP mode 1204 are bolded. The CU-level AWP flag is signaled only when the inter prediction block is coded using bi-prediction mode (bi-prediction flag 1206—true) and the inter prediction block is not coded using affine mode or symmetric motion vector difference (SMVD) mode (SMVD flag 1208 —false). FIG. 13A and FIG. 13B show an exemplary syntax including syntax structure for an AWP flag, according to some embodiments of the present disclosure. The FIG. 13B is a continuation of FIG. 13A. As shown in FIG. 13A, changes from the previous AVS are shown in italic. AWP flag (e.g., awp_flag 1301) can be signaled when SMVD is not used (e.g., smvd_flag 1302 is false) and Affine is not used (e.g., AffineFlag 1303 is false). When the AWP flag (e.g., awp_flag 1301) is true, reference indices and motion vector differences (e.g., awp_idx 1304) can be signaled using the same method as the bi-prediction mode, such as a first motion information for reference picture list 0 (L0) and a second motion information for reference picture list 1 (L1). In some embodiments, when performing the prediction, a first weight matrix w0 can be applied to the prediction block predicted using the motion information of list L0. Also, a second weight matrix (8-w0) can be applied to the prediction block predicted using the motion information of list L1. The weight matrix w0 can be derived by a weight prediction method, with values from 0 to 8.

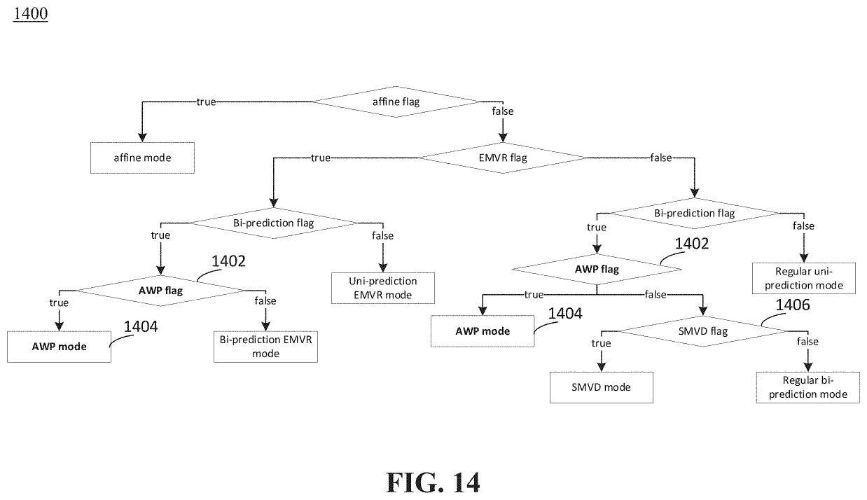

In some embodiments, the CU-level AWP flag may be signaled in different positions, for example, the AWP flag can be signaled prior to at least one of the following flags signaled: a symmetric motion vector difference (SMVD) flag, a bi-prediction flag, an extended motion vector resolution (EMVR) flag or an affine flag. FIG. 14 shows an exemplary syntax structure 1400 including syntax structure for signaling an AWP flag 1402 prior to an SMVD flag, according to some embodiments of the present disclosure. As shown in FIG. 14, an AWP flag 1402 and an AWP mode 1404 are shown in bold. In some embodiments, AWP flag 1402 is signaled prior to SMVD flag 1406, and SMVD flag 1406 is signaled when AWP flag 1402 is “false”.

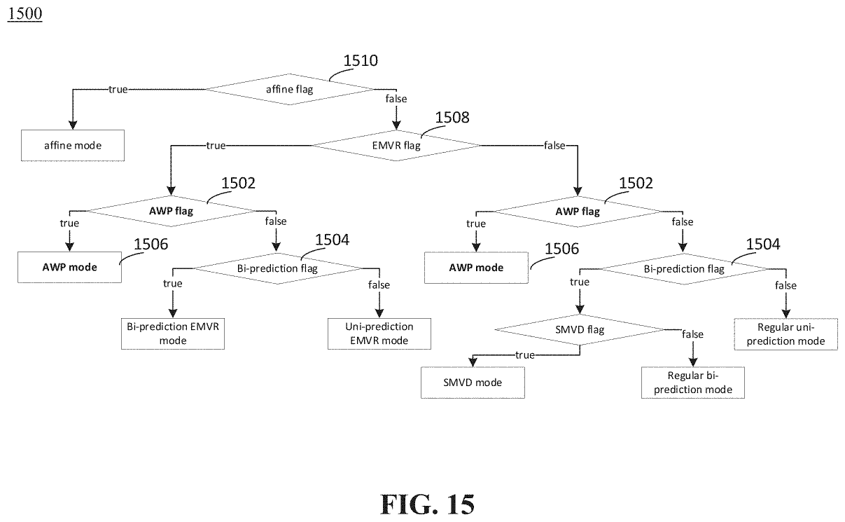

FIG. 15 shows an exemplary method 1500 for signaling an AWP flag 1502 prior to a bi-prediction flag 1504, according to some embodiments of the present disclosure. As shown in FIG. 15, an AWP flag 1502 and an AWP mode 1506 are shown in bold. In some embodiments, the CU-level AWP flag 1502 is signaled prior to bi-prediction flag 1504, and bi-prediction flag 1504 is signaled when AWP flag 1502 is false. In some embodiments, bi-prediction flag 1504 can be inferred to be true when AWP mode 1506 is used. In some embodiments, the CU-level AWP flag 1502 can be signaled prior to an EMVR flag 1508 or an affine flag 1510.

In the AWP skip and direct modes, motion information including reference index and motion vector can be predicted from the same reference picture list. In some embodiments, to be consistent in the skip and direct modes and the regular inter prediction mode, two items of motion information can be both from reference picture list 0 (L0) or reference picture list 0 (L1). Therefore, one flag for both forms of motion information can be signaled to indicate the motion information is predicted from L0 or L1.

In some embodiments, to allow more flexibility and improve coding efficiency, when the AWP flag is true, two items of motion information can be signaled, where each item of motion information includes a reference index, an MVD, an EMVR flag, and an AMVR index. Therefore, two items of motion information may have different MVD precision. For example, the EMVR flag of one motion information is true, and the EMVR flag of the other motion information is false.

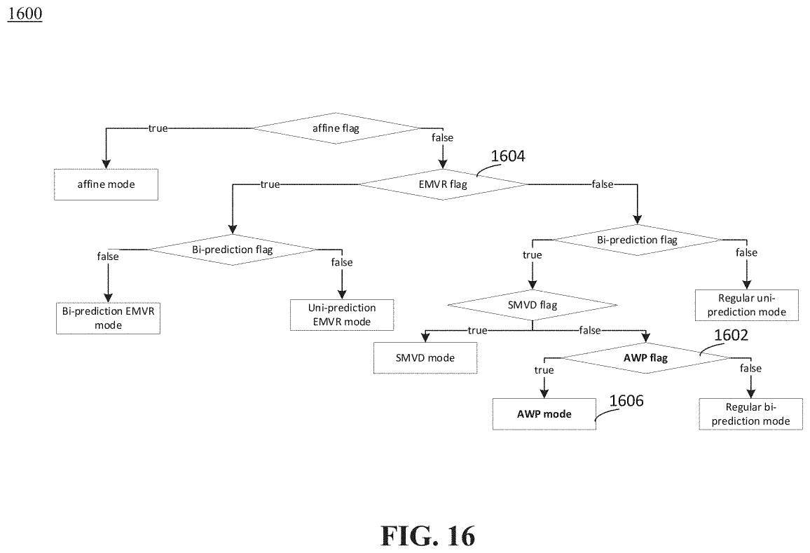

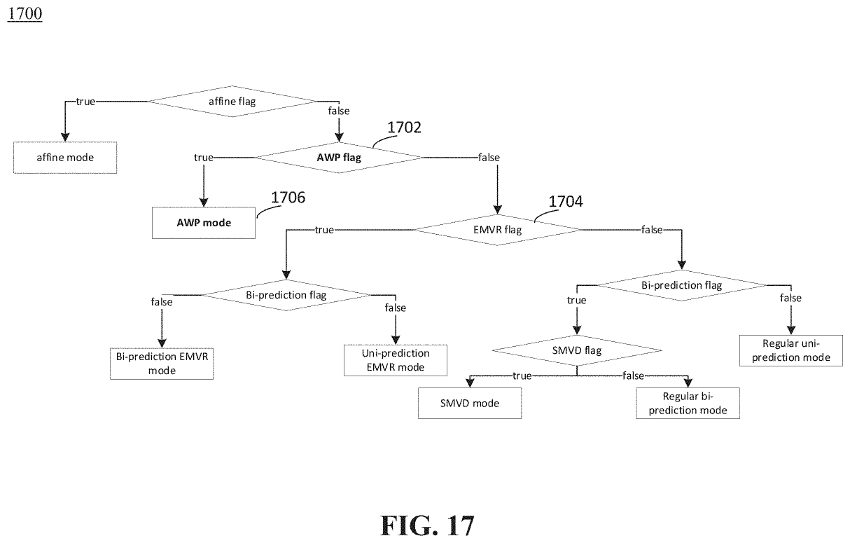

Since it may not be useful to combine the AWP mode with the EMVR mode, in some embodiments the AWP mode is not combined with the EMVR mode. For example, when the EMVR mode is on, the AWP mode is disabled. FIG. 16 and FIG. 17 shows two exemplary syntax structures 1600 and 1700, respectively, including syntax structure for an AWP flag 1602, 1702 and an EMVR flag 1604, 1704, according to some embodiments of the present disclosure.

As shown in FIG. 16, an AWP flag 1602 and an AWP mode 1606 are shown in bold. The AWP mode 1606 can only be turned on (e.g., AWP flag 1602 is “true”) when the EMVR mode is turned off (e.g., EMVR flag 1604 is “false”). As shown in FIG. 17, an AWP flag 1702 and an AWP mode 1706 are shown in bold. The EMVR mode can only be turned on (e.g., EMVR flag 1704 is “true”) when the AWP mode 1706 is turned off (e.g., AWP flag 1702 is “false”). By incorporating the syntax structures shown in FIG. 16 or FIG. 17, the AVS (e.g., AVS3) can save syntax overhead by disallowing a scenario where the AWP mode and the EMVR mode are turned on concurrently.

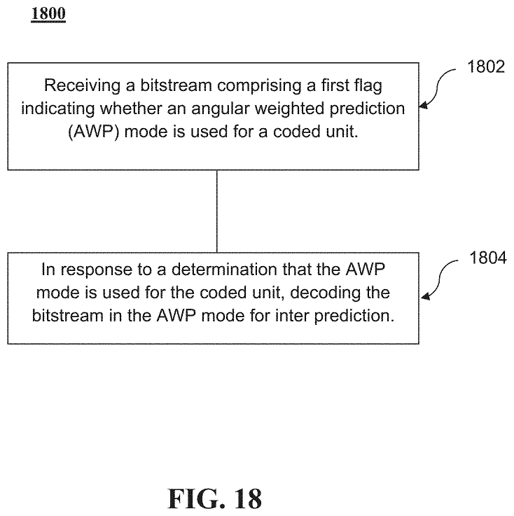

FIG. 18 shows a flow-chart of a decoding method 1800 according to some embodiments of present disclosure. Method 1800 can be performed by a decoder (e.g., by process 300A of FIG. 3A or 300B of FIG. 3B) or performed by one or more software or hardware components of an apparatus (e.g., apparatus 400 of FIG. 4). For example, a processor (e.g., processor 402 of FIG. 4) can perform method 1800. In some embodiments, method 1800 can be implemented by a computer program product, embodied in a computer-readable medium, including computer-executable instructions, such as program code, executed by computers (e.g., apparatus 400 of FIG. 4). Referring to FIG. 18, method 1800 may include the following steps 1802 and 1804. At step 1802, a bitstream comprising a first flag indicating whether an angular weighted prediction (AWP) mode is used for a coded unit is received. At step 1804, in response to a determination that the AWP mode is used for the coded unit, the bitstream is decoded in the AWP mode for inter prediction. The coded unit can be coded in a regular inter prediction mode, for example, the inter prediction is not a skip mode or a direct mode.

In some embodiment, the coded unit is further coded in one or both of bi-prediction mode and extended motion vector resolution (EMVR) mode. Therefore, the decoding method can further incudes a step of decoding the bitstream in bi-prediction mode and extended motion vector resolution (EMVR) mode. Furthermore, the coded unit is not coded in uni-prediction mode or affine mode or symmetric motion vector difference (SMVD) mode. As it may not be useful to combine the AWP mode with the EMVR mode, in some embodiments the AWP mode is not combined with the EMVR mode, therefore, the coded unit is not coded in EMVR mode.

In some embodiments, the method 1800 further includes a step of parsing two items of motion information including a motion vector difference (MVD) and a reference index from the bitstream. The two items of motion information are signaled when encoding the video frames using the AWP. In some embodiments, one item of motion information includes a reference index and the MVD for a reference picture list 0, and another item of motion information includes a reference index and the MVD for a reference picture list 1.

In some embodiments, to be consistent in the skip and direct modes and the regular inter prediction mode, the two items of motion information are predicted from a same reference picture list L0 or L1, therefore, the decoding method 1800 further includes a step of parsing the motion information being predicted from L0 or L1.

In some embodiments, the motion information further includes an EMVR flag and an AMVR index. Therefore, two items of motion information may have different MVD precision.

Embodiments of the present disclosure further provide methods to reduce encoding time when applying the AWP mode in regular inter prediction. In some embodiments, an AWP motion estimation process is performed for each weight matrix, and a predetermined encoder processing method can be performed.

In some embodiments, when the current best coding mode is not the AWP mode and the EMVR mode is turned on (e.g., EMVR flag is “true”), a motion estimation process for AWP can be skipped.

In some embodiments, when the current best coding mode is skip mode and not the AWP mode, the motion estimation process for AWP can be skipped.

In some embodiments, when the current best coding mode is not AWP mode and the AMVR index is larger than a pre-defined threshold (that means the precision is lower), only a subset of weight matrices instead of all 56 weight matrices can be tested during the motion estimation process for AWP, such that the encoding time can be reduced. In some embodiments, the subset of weight matrices can be the first seven weight matrices having the lowest cost in the previous motion estimation process for AWP.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

The embodiments may further be described using the following clauses:

1. A video encoding method, comprising:

receiving one or more video frames; and

coding the one or more video frames using an angular weighted prediction (AWP) mode for an inter prediction by signaling two items of motion information including a motion vector difference (MVD) and a reference index.

2. The method of clause 1, wherein a first item of motion information includes a first reference index and the MVD for a reference picture list 0, and a second item of motion information includes a second reference index and the MVD for a reference picture list 1.

3. The method of clause 2, further comprising:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

4. The method of clause 3, wherein the first weight matrix and the second weight matrix have values in a range from 0 to 8.

5. The method of any one of clauses 1 to 4, wherein the two items of motion information are predicted from a same reference picture list, the method further comprising: signaling a flag indicating the motion information is predicted from a reference picture list 0 or a reference picture list 1.

6. The method of any one of clauses 1 to 5, wherein the motion information further includes an extended motion vector resolution (EMVR) flag and an adaptive motion vector resolution (AMVR) index.

7. The method of any one of clauses 1 to 6, further comprising:

determining whether an affine mode is enabled for a coding unit, and

in response at least in part to the determination that the affine mode is not enabled for the coding unit, signaling a first flag indicating whether an angular weighted prediction (AWP) is applied to the inter prediction of the coding unit.

8. The method of clause 7, wherein the first flag is signaled prior to at least one determination that the coding unit is in coded of a symmetric motion vector difference (SMVD) mode, a bi-prediction mode, or an extended motion vector resolution (EMVR) mode.

9. The method of clause 8, wherein the AWP mode is disabled when the symmetric motion vector difference (SMVD) mode is used.

10 The method of clause 8, wherein the AWP mode is disabled when the extended motion vector resolution (EMVR) mode is used.

11. The method of clause 8, wherein the AWP mode is disabled when a uni-prediction mode is used.

12. The method of any one of clauses 1 to 11, further comprising:

performing a predetermined encoder processing method when the AWP mode is used.

13. The method of clause 12, wherein the predetermined encoder processing method comprises:

skipping a motion estimation process for AWP when a current coding mode is not the AWP mode and an extended motion vector resolution (EMVR) mode is turned on.

14. The method of clause 12, wherein the predetermined encoder processing method comprises:

skipping a motion estimation process for AWP when a current coding mode is a skip mode and is not the AWP mode.

15. The method of clause 12, wherein the predetermined encoder processing method comprises:

testing a subset of weight matrices during a motion estimation process for AWP, when a current coding mode is not the AWP mode and an adaptive motion vector resolution index is larger than a pre-defined threshold.

16. The method of clause 12, wherein the subset of weight matrices includes a first seven weight matrices having a lowest cost in a previous motion estimation process for AWP.

17. A video decoding method, comprising:

receiving a bitstream comprising a first flag indicating whether an angular weighted prediction (AWP) mode is used for a coded unit; and

in response to a determination that the AWP mode is used for the coded unit, decoding the bitstream in the AWP mode for an inter prediction.

18. The method of clause 17, further comprising:

in response to a determination that the AWP mode is used for the coded unit, decoding two items of motion information including a motion vector difference (MVD) and a reference index.

19. The method of clause 18, wherein a first item of motion information includes a first reference index and the MVD for a reference picture list 0, and a second item of motion information includes a second reference index and the MVD for a reference picture list 1.

20. The method of clause 19, further comprising:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

21. The method of any one of clauses 18 to 20, wherein the two items of motion information are predicted from a same reference picture list, the method further comprising:

decoding a flag indicating the motion information is predicted from a reference picture list 0 or a reference picture list 1.

22. The method of any one of clauses 18 to 21, wherein the motion information further includes an extended motion vector resolution (EMVR) flag and an adaptive motion vector resolution (AMVR) index.

23. The method of any one of clauses 17 to 22, further comprising:

determining whether an affine mode is enabled for a coding unit, and

in response at least in part to the determination that the affine mode is not enabled for the coding unit, decoding a first flag indicating whether an angular weighted prediction (AWP) is applied to the inter prediction of the coding unit.

24. The method of clause 23, wherein the first flag is signaled prior to at least one determination that the coding unit is in coded of a symmetric motion vector difference (SMVD) mode, a bi-prediction mode, or an extended motion vector resolution (EMVR) mode.

25. An apparatus for performing video data processing, the apparatus comprising:

a memory configured to store instructions, and

one or more processors communicatively coupled to the memory and configured to execute the instructions to cause the apparatus to perform:

receiving one or more video frames; and

coding the one or more video frames using an angular weighted prediction (AWP) mode for inter prediction by signaling two items of motion information including a motion vector difference (MVD) and a reference index.

26. The apparatus of clause 25, wherein a first item of motion information includes a first reference index and the MVD for a reference picture list 0, and a second item of motion information includes a second reference index and the MVD for a reference picture list 1, the processor is further configured to execute the instructions to cause the apparatus to perform:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

27. The apparatus of clause 25 or 26, wherein the two items of motion information are predicted from a same reference picture list, and the processor is further configured to execute the instructions to cause the apparatus to perform:

signaling a flag indicating the motion information is predicted from a reference picture list 0 or a reference picture list 1.

28. The apparatus of any one of clauses 25 to 27, wherein the processor is further configured to execute the instructions to cause the apparatus to perform:

determining whether an affine mode is enabled for a coding unit, and

in response at least in part to the determination that the affine mode is not enabled for the coding unit, signaling a first flag indicating whether an angular weighted prediction (AWP) is applied to an inter prediction mode of the coding unit.

29. The apparatus of any one of clauses 25 to 28, wherein the processor is further configured to execute the instructions to cause the apparatus to perform:

performing a predetermined encoder processing method when the AWP mode is used.

30. The apparatus of clause 29, wherein the processor is further configured to execute the instructions to cause the apparatus to perform:

skipping a motion estimation process for AWP when a current coding mode is not the AWP mode and an extended motion vector resolution (EMVR) mode is turned on.

31. The apparatus of clause 29, wherein the processor is further configured to execute the instructions to cause the apparatus to perform:

skipping a motion estimation process for AWP when a current coding mode is a skip mode and is not the AWP mode.

32. The apparatus of clause 29, wherein the processor is further configured to execute the instructions to cause the apparatus to perform:

testing a subset of weight matrices during a motion estimation process for AWP, when a current coding mode is not the AWP mode and an adaptive motion vector resolution index is larger than a pre-defined threshold.

33. An apparatus for performing video data processing, the apparatus comprising:

a memory configured to store instructions; and

one or more processors communicatively coupled to the memory and configured to execute the instructions to cause the apparatus to perform:

receiving a bitstream comprising a first flag indicating whether an angular weighted prediction (AWP) mode is used for a coded unit; and

in response to a determination that the AWP mode is used for the coded unit,

decoding the bitstream in the AWP mode for inter prediction.

34. The apparatus of clause 33, wherein the processor is further configured to execute the instructions to cause the apparatus to perform:

decoding two items of motion information including a motion vector difference (MVD) and a reference index from the bitstream.

35. The apparatus of clause 34, wherein a first item of motion information includes a first reference index and the MVD for a reference picture list 0, and a second item of motion information includes a second reference index and the MVD for a reference picture list 1, the processor is further configured to execute the instructions to cause the apparatus to perform:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

36. The apparatus of clause 34, wherein the processor is further configured to execute the instructions to cause the apparatus to perform:

determining whether an affine mode is enabled for a coding unit; and

in response at least in part to the determination that the affine mode is not enabled for the coding unit, decoding a first flag indicating whether an angular weighted prediction (AWP) is applied to an inter prediction mode of the coding unit.

37. The apparatus of clauses 34, wherein a first item of motion information includes a first reference index and the MVD for a reference picture list 0, and a second item of motion information includes a second reference index and the MVD for a reference picture list 1, and

the processor is further configured to execute the instructions to cause the apparatus to perform:

decoding the motion information being predicted from a reference picture list 0 or a reference picture list 1.

38. A non-transitory computer readable medium that stores a set of instructions that is executable by one or more processors of an apparatus to cause the apparatus to initiate a method for performing video data processing, the method comprising:

receiving one or more video frames; and

coding the one or more video frames using an angular weighted prediction (AWP) mode for inter prediction by signaling two items of motion information including a motion vector difference (MVD) and a reference index.

39. The non-transitory computer readable medium of clause 38, wherein a first item of motion information includes a first reference index and the MVD for a reference picture list 0, and a second item of motion information includes a second reference index and the MVD for a reference picture list 1, and the method further comprises:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

40. The non-transitory computer readable medium of clause 38 or 39, wherein the two items of motion information are predicted from a same reference picture list, and the method further comprises:

signaling a flag indicating the motion information is predicted from a reference picture list 0 or a reference picture list 1.

41. The non-transitory computer readable medium of any one of clauses 38 to 40, wherein the method further comprises:

determining whether an affine mode is enabled for a coding unit; and

in response at least in part to the determination that the affine mode is not enabled for the coding unit, signaling a first flag indicating whether an angular weighted prediction (AWP) is applied to an inter prediction mode of the coding unit.

42. The non-transitory computer readable medium of any one of clauses 38 to 41, wherein the method further comprises:

performing a predetermined encoder processing method when the AWP mode is used.

43. The non-transitory computer readable medium of clause 42, wherein the predetermined encoder processing method further comprises:

skipping a motion estimation process for AWP when a current coding mode is not the AWP mode and an extended motion vector resolution (EMVR) mode is turned on.

44. The non-transitory computer readable medium of clause 42, wherein the predetermined encoder processing method further comprises:

skipping a motion estimation process for AWP when a current coding mode is a skip mode and is not the AWP mode.

45. The non-transitory computer readable medium of clause 42, wherein the predetermined encoder processing method further comprises:

testing a subset of weight matrices during a motion estimation process for AWP, when a current coding mode is not the AWP mode and an adaptive motion vector resolution index is larger than a pre-defined threshold.

46. A non-transitory computer readable medium that stores a set of instructions that is executable by one or more processors of an apparatus to cause the apparatus to initiate a method for performing video data processing, the method comprising:

receiving a bitstream comprising a first flag indicating whether an angular weighted prediction (AWP) mode is used for a coded unit; and

in response to a determination that the AWP mode is used for the coded unit,

decoding the bitstream in the AWP mode for an inter prediction.

47. The non-transitory computer readable medium of clause 46, wherein the method further comprises:

parsing two items of motion information including a motion vector difference (MVD) and a reference index from the bitstream.

48. The non-transitory computer readable medium of clause 46, wherein a first item of motion information includes a first reference index and the MVD for a reference picture list 0, and a second item of motion information includes a second reference index and the MVD for a reference picture list 1, and the method further comprises:

applying a first weight matrix to a prediction block predicted using the first item of motion information; and

applying a second weight matrix to a prediction block predicted using the second item of motion information, wherein the first weight matrix and the second weight matrix are complementary, and the first weight matrix is derived by an AWP method.

49. The non-transitory computer readable medium of clause 46, wherein the method further comprises:

determining whether an affine mode is enabled for a coding unit; and

in response at least in part to the determination that the affine mode is not enabled for the coding unit, decoding a first flag indicating whether an angular weighted prediction (AWP) is applied to an inter prediction mode of the coding unit.

50. The non-transitory computer readable medium of clause 46, wherein a first item of motion information includes a first reference index and the MVD for a reference picture list 0, and a second item of motion information includes a second reference index and the MVD for a reference picture list 1, and the method further comprises:

decoding the motion information being predicted from a reference picture list 0 or a reference picture list 1.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video decoding method, comprising:
receiving a bitstream comprising a first flag indicating whether an angular weighted prediction (AWP) mode is used for a coded unit; and
in response to a determination that the AWP mode is used for the coded unit, decoding the bitstream in the AWP mode for an inter prediction.

2. The method of claim 1, further comprising:
in response to a determination that the AWP mode is used for the coded unit, decoding two items of motion information including a motion vector difference (MVD) and a reference index.

3. The method of claim 2, wherein a first item of motion information includes a first reference index and the MVD for a reference picture list 0, and a second item of motion information includes a second reference index and the MVD for a reference picture list 1.

4. The method of claim 3, further comprising:
applying a first weight matrix to a prediction block predicted using the first item of motion information; and
applying a second weight matrix to a prediction block predicted using the second item of motion information, wherein the first weight matrix and the second weight matrix are complementary, and the first weight matrix is derived by an AWP method.

5. The method of claim 2, wherein the two items of motion information are predicted from a same reference picture list, the method further comprising:
decoding a flag indicating the motion information is predicted from a reference picture list 0 or a reference picture list 1.

6. The method of claim 2, wherein the motion information further includes an extended motion vector resolution (EMVR) flag and an adaptive motion vector resolution (AMVR) index.

7. The method of claim 1, further comprising:
determining whether an affine mode is enabled for a coding unit, and
in response at least in part to the determination that the affine mode is not enabled for the coding unit, decoding a first flag indicating whether an angular weighted prediction (AWP) is applied to the inter prediction of the coding unit.

8. The method of claim 7, wherein the first flag is signaled prior to at least one determination that the coding unit is in coded of a symmetric motion vector difference (SMVD) mode, a bi-prediction mode, or an extended motion vector resolution (EMVR) mode.

9. A video encoding method, comprising:
receiving one or more video frames; and
coding the one or more video frames using an angular weighted prediction (AWP) mode for inter prediction by signaling two items of motion information including a motion vector difference (MVD) and a reference index.

10. The method of claim 9, further comprising:
performing a predetermined encoder processing method when the AWP mode is used.

11. The method of claim 10, wherein the predetermined encoder processing method comprises:
testing a subset of weight matrices during a motion estimation process for AWP, when a current coding mode is not the AWP mode and an adaptive motion vector resolution index is larger than a pre-defined threshold.

12. An apparatus for performing video data processing, the apparatus comprising:
a memory configured to store instructions; and
one or more processors communicatively coupled to the memory and configured to execute the instructions to cause the apparatus to perform:
receiving a bitstream comprising a first flag indicating whether an angular weighted prediction (AWP) mode is used for a coded unit;
in response to a determination that the AWP mode is used for the coded unit, decoding two items of motion information including a motion vector difference (MVD) and a reference index; and
decoding the bitstream in the AWP mode for an inter prediction.

13. The apparatus of claim 12, wherein a first item of motion information includes a first reference index and the MVD for a reference picture list 0, and a second item of motion information includes a second reference index and the MVD for a reference picture list 1, the processor is further configured to execute the instructions to cause the apparatus to perform:
applying a first weight matrix to a prediction block predicted using the first item of motion information; and
applying a second weight matrix to a prediction block predicted using the second item of motion information, wherein the first weight matrix and the second weight matrix are complementary, and the first weight matrix is derived by an AWP method.

14. The apparatus of claim 12, wherein the processor is further configured to execute the instructions to cause the apparatus to perform:
determining whether an affine mode is enabled for a coding unit, and
in response at least in part to the determination that the affine mode is not enabled for the coding unit, decoding a first flag indicating whether an angular weighted prediction (AWP) is applied to an inter prediction mode of the coding unit.

15. An apparatus for performing video data processing, the apparatus comprising:
a memory configured to store instructions; and
one or more processors communicatively coupled to the memory and configured to execute the instructions to cause the apparatus to perform:
receiving one or more video frames; and
coding the one or more video frames using an angular weighted prediction (AWP) mode for inter prediction by signaling two items of motion information including a motion vector difference (MVD) and a reference index.

16. The apparatus of claim 15, wherein the processor is further configured to execute the instructions to cause the apparatus to perform:
performing a predetermined encoder processing method when the AWP mode is used.

17. A non-transitory computer readable medium that stores a set of instructions that is executable by one or more processors of an apparatus to cause the apparatus to initiate a method for performing video data processing, the method comprising:
receiving a bitstream comprising a first flag indicating whether an angular weighted prediction (AWP) mode is used for a coded unit;
in response to a determination that the AWP mode is used for the coded unit, decoding two items of motion information including a motion vector difference (MVD) and a reference index; and
decoding the bitstream in the AWP mode for an inter prediction.

18. The non-transitory computer readable medium of claim 17, wherein a first item of motion information includes a first reference index and the MVD for a reference picture list 0, and a second item of motion information includes a second reference index and the MVD for a reference picture list 1, and the method further comprises:
applying a first weight matrix to a prediction block predicted using the first item of motion information; and
applying a second weight matrix to a prediction block predicted using the second item of motion information, wherein the first weight matrix and the second weight matrix are complementary, and the first weight matrix is derived by an AWP method.

19. The non-transitory computer readable medium of claim 17, wherein the method further comprises:
determining whether an affine mode is enabled for a coding unit, and
in response at least in part to the determination that the affine mode is not enabled for the coding unit, decoding a first flag indicating whether an angular weighted prediction (AWP) is applied to an inter prediction mode of the coding unit.

20. A non-transitory computer readable medium that stores a set of instructions that is executable by one or more processors of an apparatus to cause the apparatus to initiate a method for performing video data processing, the method comprising:
receiving one or more video frames; and
coding the one or more video frames using an angular weighted prediction (AWP) mode for an inter prediction by signaling two items of motion information including a motion vector difference (MVD) and a reference index.
